(19) United States
(12) Patent Application Publication
(10) Pub. No.: US 2025/0092199 A1
(43) Pub. Date: Mar. 20, 2025

(54) POLYAMIDE COMPOSITION

(71) Applicant: Bostik SA, COLOMBES (FR)

(72) Inventors: Héloïse HABRANT, VENETTE (FR); Stéphane JARNIAS, VENETTE (FR)

(21) Appl. No.: 18/576,792

(22) PCT Filed: Jul. 20, 2022
(86) PCT No.: PCT/FR2022/051439

§ 371 Date: Jan. 5, 2024

(30) Foreign Application Priority Data
Jul. 22, 2021 (FR) FR2107911

(51) Int. Cl. C08G 69/34; C08G 69/26; C09J 1/00

(52) U.S. Cl. CPC C08G 69/34; C08G 69/265; C09J 1/00; C08G 2170/00

(57) ABSTRACT

The present invention relates to a polyamide composition comprising a polyamide which is the poly condensation product of an acid component and an amine component, the acid component comprising, per mole of acid component; −30 to 50 mol. % of fatty acid dimer(s); −30 to 50 mol. % of aliphatic dibasic acid(s); −0 to 10 mol. % of chain limiter(s); the amine component comprising, per mole of amine component; −10 to 40 mol. % of cycloaliphatic diamine(s); and −50 to 80 mol. % of aliphatic diamine(s) comprising 3 to 12 carbon atoms); −0 to 15 mol. % of polyetheramine(s); said polyamide composition having; —a viscosity less than or equal to 4 Pa·s at 185° C.; and —a softening temperature ranging from 150° C. to 170° C.

### FIELD OF THE INVENTION

The present invention relates to a polyamide composition, to its uses and also to a moulded article deriving therefrom and to its process of manufacture.

The polyamide composition is particularly suitable as hot-melt adhesive for the low-pressure and low-temperature overmoulding of a heat-sensitive battery, for example a lithium-polymer battery.

### TECHNICAL BACKGROUND

Numerous portable electronic devices are equipped with batteries, allowing them to be used without having to be connected to the electricity supply network. In order to confer sufficient strength on them, to protect them from the environmental conditions and to prevent inappropriate handling by the user, the batteries are generally packaged in a protective casing. Generally, the casings of the batteries can be formed by overmoulding starting from plastics, for example starting from polyamides, injected at low pressure.

Although batteries exhibiting a satisfactory performance are already available, for example lithium-ion batteries, new technical (battery life, performance, weight, and the like), industrial (starting materials, and the like) and/or regulatory (interoperability, recyclability, and the like) constraints require the development of alternative technologies, such as lithium-polymer batteries.

Lithium-polymer batteries (or lithium ion-polymer batteries)—also denoted LiPo, LIP, Li-poly, lithium-poly—are rechargeable batteries using a polymer electrolyte instead of a liquid electrolyte. These batteries are advantageous in that they can be replaced, without destroying or damaging the electronic devices containing them. This makes it possible to increase the lifetime of the electronic devices. In addition, this makes possible the recycling of the battery, when the electronic devices containing them have broken down. Finally, these batteries exhibit a satisfactory performance. On the other hand, these batteries have the disadvantage of being sensitive to the temperature and to the pressure. The conventional processes for low-pressure overmoulding used, for example, for lithium-ion batteries are not suitable, in that they use plastics, for example polyamides, which have to be injected at high temperatures, generally of greater than 200° C., due in particular to their high viscosities.

Overmoulding processes and/or different polyamide compositions are well known.

However, there exists a real need to provide novel polyamide adhesive compositions which are suitable for low-pressure and low-temperature injection processes. In particular, there exists the need to provide polyamide compositions suitable for processes for the overmoulding of heat-sensitive elements, in particular lithium-polymer batteries. In particular, there exists the need to provide polyamide compositions, suitable for processes for the overmoulding of heat-sensitive elements, which are also suitable (after overmoulding) for withstanding the heat given off by said batteries in operation.

There exists in particular the need to provide polyamide compositions which can be injected and moulded at lower temperatures than conventional overmoulding processes, while retaining good mechanical and thermal properties.

There also exists the need to provide polyamide compositions which, after having been injected and moulded over heat-sensitive devices, can be easily recycled.

### DESCRIPTION OF THE INVENTION

The present invention relates to a polyamide composition comprising a polyamide which is the product of the polycondensation of an acid component and of an amine component, the acid component comprising, per mole of acid component:
from 30 to 50 mol % of fatty acid dimer(s);
from 30 to 50 mol % of aliphatic diacid(s);
from 0 to 10 mol % of chain limiter(s);
the amine component comprising, per mole of amine component:
from 10 to 40 mol % of cycloaliphatic diamine(s); and
from 50 to 80 mol % of aliphatic diamine(s) comprising from 3 to 12 carbon atoms;
from 0 to 15 mol % of polyetheramine(s);
said polyamide composition having:
a viscosity of less than or equal to 4 Pa·s at 185° C.; and
a softening point ranging from 150° C. to 170° C.

The viscosity is measured according to Standard ASTM D3236-15 (2021), using a Brookfield device and an SC4-A27 needle.

The polyamide composition according to the invention preferably has a viscosity at 185° C. ranging from 0.5 to 4 Pa·s, more preferably from 1 to 4 Pa·s and more preferentially still from 2 to 3.5 Pa·s.

The softening point can be measured according to Standard ASTM D3461-18 (2018), using a cup and ball device and a temperature gradient of 2° C./min.

The polyamide composition preferably has a softening point ranging from 150° C. to 165° C., more preferentially still from 155° C. to 165° C.

### Fatty Acid Dimers

The acid component can comprise, per mole of acid component, from 40 to 50 mol %, preferably from 42 to 49 mol % and more preferentially still from 44 to 49 mol % of fatty acid dimer(s).

Fatty acid dimers are polymerized fatty acids which denote compounds produced from coupling reactions of unsaturated fatty acids which result in mixtures of products carrying two acid functions. The fatty acid dimer can be obtained by a dimerization reaction of unsaturated monocarboxylic acids. The fatty acid dimer is thus the reaction product of the coupling of unsaturated monocarboxylic acids. The unsaturated monocarboxylic acids can be chosen from unsaturated monocarboxylic acids comprising from 10 to 22 carbon atoms (C₁₀ to C₂₂); preferentially from unsaturated monocarboxylic acids comprising from 12 to 18 carbon atoms (C₁₂ to C₁₈); very preferentially from unsaturated monocarboxylic acids comprising from 16 to 18 carbon atoms (C₁₆ to C₁₈).

The fatty acid dimers can be obtained, from unsaturated monocarboxylic acids, by well-known processes, such as described, for example, in Patent Applications U.S. Pat. Nos. 2,793,219 and 2,955,121. The unsaturated monocarboxylic acids can be chosen from oleic acid, linoleic acid, linolenic acid and their mixtures.

According to whether they are crude or distilled, the fatty acid dimers can exhibit a content of dimers ranging from 75% to more than 98%, as a mixture with greater or lesser amounts of monomers, trimers and higher homologues, according to the commercial grade.

Fatty acid dimers are available commercially under the names Radiacid® from Oleon, Pripol® from Croda or Unydime® from Kraton.

### Aliphatic Diacids

Throughout the description, the expressions “diacid”, “carboxylic diacid” and “dicarboxylic acid” denote the same product.

The acid component can comprise, per mole of acid component, from 35 to 50 mol %, preferably from 39 to 50 mol % and more preferentially still from 42 to 48 mol % of aliphatic diacid(s).

The aliphatic diacid can be chosen from saturated aliphatic dicarboxylic acids, preferably from saturated, linear or branched, aliphatic dicarboxylic acids.

The dicarboxylic acids can be chosen from the group consisting of succinic acid (butanedioic acid) (C₄), glutaric acid (pentanedioic acid) (C₅), adipic acid (hexanedioic acid) (C₆), pimelic acid (heptanedioic acid) (C₇), suberic acid (octanedioic acid) (C₈), azelaic acid (nonanedioic acid) (C₉), sebacic acid (decanedioic acid) (C₁₀), undecanedioic acid (C₁₁), dodecanedioic acid (C₁₂), brassylic acid (tridecanedioic acid) (C₁₃), tetradecanedioic acid (C₁₄), pentadecanedioic acid (C₁₅), thapsic acid (hexadecanedioic acid) (C₁₆) and their mixtures; more preferentially still from azelaic acid (C₉), sebacic acid (C₁₀), dodecanedioic acid (C₁₂) and their mixtures.

Preferably, the saturated aliphatic dicarboxylic acids comprise from 4 to 22 carbon atoms (C₄₋₂₂), more preferentially still from 6 to 20 (C₆₋₂₀) and more preferentially still from 9 to 18 (C₉₋₁₈).

According to one embodiment, sebacic acid (C₁₀) or dodecanedioic acid (C₁₂) represents at least 75 mol % of the aliphatic dicarboxylic acids, preferably at least 80 mol %.

The acid component comprises, in total, at least 70 mol %, preferably at least 80 mol % and more preferentially still at least 90 mol % of fatty acid dimer(s) and of aliphatic diacid(s).

### Chain Limiters

The polyamide can be synthesized in the presence of one or more chain limiter(s).

The chain limiter can be chosen from monocarboxylic acids which can comprise at least one heteroatom (O, S, Cl, F) or the corresponding esters, or monoisocyanates.

Preferably, the chain limiter is a monocarboxylic acid.

The monocarboxylic acid can be chosen from aliphatic monocarboxylic acids, alicyclic acids, aromatic monocarboxylic acids and their mixtures.

The monocarboxylic acid can be an aliphatic monocarboxylic acid chosen from acetic acid, propionic acid, lactic acid, valeric acid, caproic acid, capric acid, lauric acid, tridecylic acid, myristic acid, palmitic acid, stearic acid, pivalic acid, isobutyric acid or their mixtures.

The alicyclic acid can be a cyclohexanecarboxylic acid.

The aromatic monocarboxylic acid can be chosen from benzoic acid, toluic acid, α-naphthalenecarboxylic acid, β-naphthalenecarboxylic methylnaphthalenecarboxylic acid, phenylacetic acid and their mixtures. acid,

Preferably, the chain limiter is an aliphatic monocarboxylic acid.

Mention may be made, for example, of the Radiacid® products available commercially from Oleon.

The acid component can comprise, per mole of acid component, from 1 to 10 mol % of chain limiter(s), preferably from 3 to 10 mol % and more preferentially still from 4 to 8 mol %.

### Aliphatic Diamines

The amine component can comprise, per mole of amine component, from 50 to 75 mol %, preferably from 55 to 75 mol % and more preferentially still from 55 to 70 mol % of aliphatic diamine(s) comprising from 3 to 12 carbon atoms.

The aliphatic diamine can be chosen from saturated, linear or branched, aliphatic diamines comprising from 3 to 12 carbon atoms.

The advantageous branched aliphatic diamines include 2-methylpentamethylenediamine, 1,3-pentanediamine, methylpentanediamine and trimethylhexamethylenediamine.

Preferably, the aliphatic diamine is chosen from saturated linear aliphatic diamines of formula H₂N—(CH₂)ₙ—NH₂ with n ranging from 3 to 12.

The aliphatic diamine can be from the group consisting of propanediamine, butanediamine, pentanediamine, hexanediamine, decanediamine and their mixtures.

More preferably, the aliphatic diamine is hexanediane.

### Cycloaliphatic Diamines

The amine component can comprise, per mole of amine component, from 20 to 40 mol %, preferably from 25 to 40 mol % and more preferentially still from 25 to 35 mol % of cycloaliphatic diamine(s).

The cycloaliphatic diamine can be chosen from bis(3,5-dialkyl-4-aminocyclohexyl) methane, bis(3,5-dialkyl-4-aminocyclohexyl) ethane, bis(3,5-dialkyl-4-aminocyclohexyl) propane, bis(3,5-dialkyl-4-aminocyclohexyl) butane, bis(3-methyl-4-aminocyclohexyl) methane (BMACM or MACM), bis(p-aminocyclohexyl) methane (PACM), isopropylidenedi (cyclohexylamine) (PACP), isophoronediamine, piperazine, aminoethylpiperazine, dimethylpiperazine, 4,4′-trimethylenedipiperidine, 1,4-cyclohexanediamine, a cycloaliphatic diamine having a carbon-based backbone (for example norbornylmethane, cyclohexylmethane, dicyclohexylpropane, di(methylcyclohexyl), di(methylcyclohexyl) propane) and their mixtures.

Preferably, the cycloaliphatic diamine is piperazine.

A non-exhaustive list of these cycloaliphatic diamines is given in the publication “Cycloaliphatic Amines” (Encyclopedia of Chemical Technology, Kirk-Othmer, 4th Edition (1992), pp. 386-405).

### Polyetheramines

The amine component can comprise, per mole of amine component, from 2 to 15 mol %, preferably from 5 to 15 mol % and more preferentially still from 5 to 12 mol % of polyetheramine(s).

The polyetheramine can be chosen from polyoxyalkylene diamines with a number-average molecular weight (Mn) ranging from 200 to 4000 g/mol.

Preferably, it concerns a polyoxyalkylene chain carrying an amine group at the chain end.

The polyetheramine can be chosen from polyoxypropylenediamines, polyoxybutylenediamines, bis(diaminopropyl) polytetrahydrofuran and their mixtures.

Preferably, the polyetheramine is a polyoxypropylenediamine.

Polyetheramines are available commercially under the Jeffamine® name from Huntsman and the Baxxodur® name from BASF.

### Polyamide

According to one embodiment, the amine component does not comprise a fatty amine dimer.

Preferably, the amine component does not comprise ethylenediamine (EDA). The inventors have advantageously shown that the polyamide compositions exhibited good injection and mould release properties and confer satisfactory mechanical properties on the moulded articles, and this despite the absence of ethylenediamine.

The polyamide can have a weight-average molecular weight ranging from 5000 to 200 000 g/mol, preferably from 10 000 to 150 000 g/mol, more preferably still from 30 000 to 100 000 g/mol.

The weight-average molecular weight (Mw) of the polyamide can be measured by gel permeation chromatography (GPC).

The —COOH/(—NH and/or —NH₂) molar ratio in the polyamide can range from 0.95 to 1.30, preferably from 0.98 to 1.20, preferentially from 1.00 to 1.15.

The —COOH/(—NH and/or —NH₂) molar ratio between the carboxylic functions and the primary and/or secondary amine functions, the contents of which are expressed in mg KOH/g, is determined by potentiometry.

The polyamide can be terminated either, on the one hand, by an acid or, on the other hand, by an amine or by a mixture of acid and of amine. Preferably, the polyamide is terminated by an acid.

The polyamide according to the invention can have an acid number AN ranging from 0.28 to 17 mg KOH/g, preferably from 0.5 to 15 mg KOH/g, very preferentially from 1 to 12 mg KOH/g.

The acid number (AN), determined by potentiometry according to Standard ASTM D 4662 and Standard ISO 2114, represents the amount of carboxyl functional groups expressed as milligrams of potassium hydroxide necessary to neutralise the acidity of 1 gram of polyamide (mg KOH/g).

According to one embodiment, the polyamide is the product of the polycondensation of an acid component and of an amine component, the acid component comprising, per mole of acid component:
from 42 to 49 mol % of fatty acid dimer(s);
from 39 to 50 mol % of aliphatic diacid(s);
from 3 to 10 mol % of chain limiter(s);
the amine component comprising, per mole of amine component:
from 25 to 40 mol % of cycloaliphatic diamine(s); and
from 55 to 75 mol % of aliphatic diamine(s) comprising from 3 to 12 carbon atoms;
from 5 to 15 mol % of polyetheramine(s);

the —COOH/(—NH and/or —NH₂) molar ratio preferably ranging from 0.98 to 1.20, more preferentially still from 1.00 to 1.15.

The polyamide can have a viscosity of less than or equal to 4 Pa·s at 185° C., preferably ranging from 0.5 to 4 Pa·s, more preferably from 1 to 4 Pa·s and more preferentially still from 2 to 3.5 Pa·s.

The polyamide can have a softening point ranging from 150° C. to 170° C.

The polyamide can be obtained by polycondensation of the acid component and of the amine component according to a conventional process. The polyamide can in particular be prepared by mixing the reactants and then heating up to a temperature of greater than or equal to 100° C., preferably of greater than or equal to 150° C. and more preferentially still of greater than or equal to 200° C.

The reaction can be carried out under an inert atmosphere, such as, for example, under nitrogen.

A second stage of heating at a pressure of between 500 and 50 000 Pa (5 and 500 mbar) can be carried out in order to make possible the removal of traces of water, and of all volatile compounds.

### Polyamide Composition

The polyamide composition is preferably a hot-melt adhesive composition.

The polyamide composition can comprise more than 90% by weight of abovementioned polyamide, preferably more than 92% by weight and more preferentially still more than 95% by weight, with respect to the total weight of said polyamide composition.

The polyamide composition can comprise, besides the polyamide obtained by polycondensation of the acid component and of the amine component, at least one additive.

The additive can be chosen from fillers, antioxidants or stabilizers, mould-release agents, surfactants, pigments and their mixtures.

Mention may be made, among the mould-release agents, for example, of ethylene bis-stearamide.

Mention may be made, among the pigments, for example, of carbon black.

Mention may be made, among the antioxidants, for example, of amine, phenolic or phosphorus compounds.

The polyamide composition can comprise from 0% to 10%, preferably from 1% to 8, of additives, and more preferentially still from 1% to 6%, with respect to the total weight of said adhesive composition.

In one embodiment, the polyamide composition is devoid of tackifying resin.

The polyamide composition can be obtained by simple mixing of the ingredients, for example by mixing the polyamide as defined above with optionally one or more additives.

The polyamide composition can have a glass transition temperature Tg ranging from 0° C. à-67° C., preferably from −10° C. to −60° C. and more preferentially still from −40° C. to −60° C.

The glass transition temperature of the composition can be measured by differential scanning calorimetry, in particular according to the following method: first stage of heating from −70° C. to 250° C. at 30 K/min, then cooling from 250° C. to −70° C. at 10 K/min, maintenance at −70° C. for 10 min, then heating up to 250° C. at 15 K/min, everything under an inert atmosphere.

Surprisingly, the inventors have demonstrated that the polyamide composition according to the present invention is particularly suitable for the manufacture of casings for batteries, in particular for lithium-polymer batteries. This is because the polyamide composition can be injected at low pressure and at low temperature, in particular at a temperature of less than or equal to 185° C., which is particularly suitable for the overmoulding of heat-sensitive elements, in particular heat-sensitive batteries. In addition, although the viscosity and the softening point of the polyamide composition are lower than the viscosities and than the softening points of known polyamide compositions used in processes for the overmoulding of batteries, the casing thus obtained by overmoulding exhibits satisfactory mechanical and thermal properties, in particular a satisfactory impact strength (elongation at break and tensile strength in particular), at high temperature gradients in use (for example as a function of the seasons and of the electronic device heating). Furthermore, the polyamide compositions advantageously exhibit good injection and mould release properties (this is because the polyamide composition advantageously exhibits a rapid uptake in cohesion which makes possible easy removal from the mould). In addition, the polyamide composition advantageously withstands the operating conditions of the batteries which induce heat (temperature of greater than or equal to 100° C.) the overmoulded composition does not yield. Finally, the adhesion of the injected and moulded polyamide composition to various types of substrate (for example an aluminium-polyester substrate) is satisfactory.

The polyamide composition advantageously results in a tensile strength of greater than or equal to 3 MPa. The tensile strength can be measured according to Standard ISO 527 by preparing test specimens of 1A type and by tensioning these test specimens using a dynamometer, at a rate of 50 mm/min.

The polyamide composition can additionally exhibit an elongation at break of greater than or equal to 80%, preferably of greater than or equal to 90%, more preferentially still of greater than or equal to 100%. The elongation at break can be measured according to Standard ISO 527 by preparing test specimens of 1A type and by tensioning these test specimens using a dynamometer, at a rate of 50 mm/min.

The polyamide composition can additionally exhibit a Shore D hardness of greater than or equal to 20, preferably of greater than or equal to 25. The Shore D hardness can be measured according to Standard ISO 868, by using a durometer with recording of values immediately and after 15 sec.

### Moulded Article

The present invention additionally relates to a moulded article comprising an insert and the polyamide composition as defined above, said insert being overmoulded at least in part by the polyamide composition. Said insert can be a battery, preferentially a heat-sensitive battery, very preferentially a lithium-polymer battery.

The moulded article can additionally comprise a substrate. The substrate can be obtained from materials chosen from plastic, metal, glass, ceramic or any other appropriate substance, preferentially plastic.

In particular, the plastic can be an aluminium-polyester complex.

In one embodiment, the polyamide composition can be injected between the insert and the substrate, in order to ensure the adhesion of the two parts together, leaktightness and impact protection. In this configuration, the substrate forms the exterior casing of the moulded article. In another embodiment, the polyamide composition can be injected around the insert, and the substrate, if present. In this configuration, the overmoulded polyamide composition forms the exterior casing of the moulded article. Any alternative configuration can be envisaged.

The insert, around which the polyamide composition is overmoulded, can be any suitable insert, in particular a battery, especially a rechargeable battery, for example the batteries used in electronic devices, such as telephones, laptops and electric vehicles. In a preferred embodiment, the insert is a polymer-lithium battery.

The moulded article can be obtained from any suitable moulding process, for example by extrusion, cast moulding, injection moulding, compression moulding or transfer moulding.

In a preferred embodiment, the moulded article is obtained by a process by low-temperature and low-pressure injection, such as described below.

### Process for the Manufacture of a Moulded Article

The present invention also relates to a process for the manufacture of a moulded article.

The process by low-temperature and low-pressure injection can comprise the following stages:
provision of a mould;
insertion of the parts to be adhesively bonded (insert) into the mould, preferentially a lithium-polymer battery;
heating the polyamide composition to a temperature of 185° C. or less, preferentially of 175° C. or less, in order to obtain a molten polyamide composition;
injection of the molten polyamide composition at a pressure of from 0.5×10⁵ to 50×10⁵ Pa, preferentially from 2×10⁵ to 40×10⁵ Pa;
cooling of the injected polyamide composition;
optionally removal from the mould of the molten article obtained.

According to the configuration, the mould can form an integral part of the moulded article (for example if the polyamide composition is injected between the insert and the substrate) or can be removed after the overmoulding of the polyamide composition.

The use of the polyamide composition for obtaining moulded articles is particularly advantageous in that it is can be moulded at low pressure, in that it exhibits satisfactory flow properties at moulding temperatures of 185° C. or less and in that it exhibits a satisfactory temperature strength in the moulded state. These properties are suitable for the moulding of electronic devices which are sensitive to high temperatures and which generate heat, in particular lithium-polymer batteries.

### Use

The present invention also relates to the use of the polyamide composition as defined above, as hot-melt adhesive for the low-pressure overmoulding of a heat-sensitive battery, preferentially a lithium-polymer battery, and optionally of its substrate.

### EXAMPLE

The following example illustrates the invention without limiting it.

### Materials Used

Fatty acid dimer: Radiacid 0970® (fatty acid dimer, refined, high purity) from Oleon;
Fatty monoacid: Radiacid 0411® (fatty monoacid) from Oleon;
Fatty diacid 1: sebacic acid from Casda Biomaterials;
Fatty diacid 2: dodecanedioic acid from Chematek;
Fatty diacid 3: azelaic acid from Emery;

Aliphatic diamine: hexanediamine from BASF;
Cyclic diamine: piperazine from BASF;
Polyetheramine: Jeffamine D2000® (polyoxypropylenediamine) from Huntsman;
Antioxidant: Irganox 1010 from BASF;
Pigment: liquid composition Habisol Schwarz H28596 based on carbon black (carbon black content 2.5-10%) from Habich;

Mould-release agent: Crodamide EBS from Croda (ethylene bis-stearamide).

### Shore D Hardness Measurement

The Shore D hardnesses were measured according to Standard ISO 868.

The composition was poured into a polyethylene capsule at least 5 mm in height. The measurement value was recorded on the chosen durometer (D) after 15 seconds. Several measurements were taken, and a mean was calculated.

### The Tests of Intrinsic Mechanical Performance Qualities were Carried out According to Standard ISO 527-2017)

The measurement of the elongation at break by a tensile test was carried out according to the protocol described below.

The principle of the measurement consists in drawing, in a tensile testing device, the movable jaw of which moves at a constant rate equal to 50 mm/minute, a standard test specimen consisting of the moulded article (cf. below) and in recording, at the moment when the test specimen breaks, the maximum tensile stress (in MPa) and also the elongation of the test specimen (in %). The standard test specimen is dumbbell-shaped, as illustrated in International Standard ISO 527. The narrow part of the dumbbell used has a length of 80 mm, a width of 10 mm and a thickness of 4 mm.

### Process for the Preparation of the Polyamide

All of the reactants are charged in a suitable mixer-equipped reactor and then heated under nitrogen for 4h 30 up to a temperature of 225° C. Subsequently, the reactor is maintained at this temperature for 2h 30 and then placed under vacuum at a pressure of between 1000 and 5000 Pa for 1h.

Polyamides

| | P1 | P2 | P3 |
|---|---|---|---|
| | invention | invention | comparative |
| Acid component (mol %) | | | |
| Fatty acid dimers | 47 | 46 | 47.6 |
| Fatty diacid 1 | 39 | — | 47.6 |
| Fatty diacid 2 | — | 46 | — |
| Fatty diacid 3 | 9 | — | — |
| Fatty monoacid | 5 | 8 | 4.8 |
| Amine component (mol %) | | | |
| Aliphatic diamine (mol %) | 60 | 60 | 30 |
| Cycloaliphatic diamine | 33 | 33 | 60 |
| Polyetheramine | 7 | 7 | 10 |

### Process for the Preparation of the Polyamide Compositions

In the abovementioned reactor, once the polyamide has reached the required specifications, the temperature is maintained at 225° C. and the additives are added with stirring.

### Polyamide Composition

| | Compositions | | |
|---|---|---|---|
| | C1 | C2 | C3 |
| | invention | invention | comparative |
| Polyamide | P1 | P2 | P3 |
| Polyamide content (% by | 96.1 | 96.1 | 97.9 |
| weight with respect to the total | | | |
| composition) | | | |
| Antioxidant | 2.10 | 2.10 | 2.10 |
| Pigment | 0.8 | 0.8 | — |
| Mould-release agent | 1 | 1 | — |
| Ratio acid (COOH):amine | 1.08 | 1.0 | 1.0 |
| (primary and/or secondary) end | | | |
| groups | | | |
| Acid number (mg KOH/g) | 7.3 | 4.4 | 3.8 |

### Preparation of the Moulded Article

Once the polyamide composition has reached the required specifications, the sample is ready to be extracted. The polyamide composition is transferred into a heat gun in order to be injected into a dumbbell mould of 1A type for measurement of the mechanical properties. A few seconds after the injection, the mould is opened and the test specimens are removed from the mould. The test specimens are stored for three days in a heat-sealed aluminium bag in order to prevent uptake of moisture. On conclusion of the three days, the test specimens are tensioned using a dynamometer (cf. method above).

### Results

| | C1 | C2 | C3 |
|---|---|---|---|
| Compositions | invention | invention | comparative |
| Viscosity (185° C.) (mPa · s) | 2800 | 3300 | 4060 |
| Softening point (° C.) | 154.9 | 161.3 | 115.20 |
| Tensile strength (MPa) | 4.4 | 5.0 | Nd |
| Elongation at break (%) | 93 | 100 | Nd |
| Shore D hardness | 28 | 29 | Nd |

The comparative composition C3 does not make possible the removal from the mould of the article a few seconds after the injection, which makes it impossible to prepare a dumbbell for measurement of the mechanical properties. This is because the product is soft and lacks cohesion. The overmoulding of electronic parts, and thus of batteries, is also impossible.

The compositions C1 and C2 (according to the invention), respectively comprising the polyamides P1 and P2, have a viscosity and a softening point which are particularly suitable for their use as hot-melt adhesive in processes for the overmoulding of heat-sensitive inserts, in particular lithium-polymer batteries, and make it possible to obtain moulded articles with satisfactory mechanical and thermal properties. This is because the compositions C1 and C2 advantageously result in a moulded article exhibiting a tensile strength of 4.4 MPa (C1) and 5.0 (C2), and a satisfactory elongation at break: 93% (C1) and 100% (C2). Furthermore, the compositions C1 and C2 advantageously have a rapid uptake in cohesion which makes possible easy removal from the mould.

1-20. (canceled)

21. Polyamide composition comprising a polyamide which is the product of polycondensation of an acid component and of an amine component,
the acid component comprising, per mole of acid component:
from 30 to 50 mol % of fatty acid dimer(s);
from 30 to 50 mol % of aliphatic diacid(s); and
from 0 to 10 mol % of chain limiter(s);
the amine component comprising, per mole of amine component:
from 10 to 40 mol % of cycloaliphatic diamine(s);
from 50 to 80 mol % of aliphatic diamine(s) comprising from 3 to 12 carbon atoms; and
from 0 to 15 mol % of polyetheramine(s);
said polyamide composition having:
a viscosity of less than or equal to 4 Pa·s at 185° C.; and
a softening point ranging from 150° C. to 170° C.

22. Composition according to claim 21, characterized in that it has a viscosity at 185° C. ranging from 0.5 to 4 Pa·s.

23. Composition according to claim 21, characterized in that it has a softening point ranging from 150° C. to 165° C.

24. Composition according to claim 21, characterized in that the fatty acid dimer is the reaction product of a coupling of unsaturated monocarboxylic acids.

25. Composition according to claim 21, characterized in that the aliphatic diacid is chosen from saturated aliphatic dicarboxylic acids.

26. Composition according to claim 25, characterized in that sebacic acid (C₁₀) or dodecanedioic acid (C₁₂) represents at least 75 mol % of the aliphatic dicarboxylic acids.

27. Composition according to claim 21, characterized in that the chain limiter is chosen from monocarboxylic acids which can comprise at least one heteroatom (O, S, Cl, F) or the corresponding esters, or monoisocyanates.

28. Composition according to claim 21, characterized in that the aliphatic diamine is chosen from saturated, linear or branched, aliphatic diamines comprising from 3 to 12 carbon atoms.

29. Composition according to claim 21, characterized in that the aliphatic diamine is hexanediamine.

30. Composition according to claim 21, characterized in that the cycloaliphatic diamine is chosen from bis(3,5-dialkyl-4-aminocyclohexyl) methane, bis(3,5-dialkyl-4-aminocyclohexyl) ethane, bis(3,5-dialkyl-4-aminocyclohexyl) propane, bis(3,5-dialkyl-4-aminocyclohexyl) butane, bis(3-methyl-4-aminocyclohexyl) methane (BMACM or MACM), bis(p-aminocyclohexyl) methane (PACM), isopropylidenedi(cyclohexylamine) (PACP), isophoronediamine, piperazine, aminoethylpiperazine, dimethylpiperazine, 4,4′-trimethylenedipiperidine, 1,4-cyclohexanediamine, a cycloaliphatic diamine having a carbon-based backbone (for example norbornylmethane, cyclohexylmethane, dicyclohexylpropane, di(methylcyclohexyl), di(methylcyclohexyl) propane) and their mixtures.

31. Composition according to claim 21, characterized in that the amine component does not comprise ethylenediamine (EDA).

32. Composition according to claim 21, characterized in that the amine component comprises, per mole of amine component, from 2 to 15 mol %.

33. Composition according to claim 21, characterized in that the polyamide is the product of polycondensation of an acid component and of an amine component,
the acid component comprising, per mole of acid component:
from 42 to 49 mol % of fatty acid dimer(s);
from 39 to 50 mol % of aliphatic diacid(s); and
from 3 to 10 mol % of chain limiter(s);
the amine component comprising, per mole of amine component:
from 25 to 40 mol % of cycloaliphatic diamine(s);
from 55 to 75 mol % of aliphatic diamine(s) comprising from 3 to 12 carbon atoms; and
from 5 to 15 mol % of polyetheramine(s).

34. Composition according to claim 21, characterized in that it comprises more than 90% by weight of polyamide as defined according to claim 21, with respect to the total weight of said polyamide composition.

35. Composition according to claim 21, characterized in that it has a glass transition temperature Tg ranging from 0° C. to −67° C.

36. Composition according to claim 21, characterized in that it results in a tensile strength of greater than or equal to 3 MPa.

37. Composition according to claim 21, characterized in that it exhibits an elongation at break of greater than or equal to 80%.

38. Composition according to claim 21, characterized in that it is a hot-melt adhesive composition.

39. Moulded article comprising an insert and the polyamide composition according to claim 21, said insert being overmoulded at least in part by the polyamide composition.

40. A hot-melt adhesive for the low-pressure overmoulding of a heat-sensitive battery comprising the polyamide composition according to claim 21.
